(19) United States
(12) Patent Application Publication
(10) Pub. No.: US 2026/0238611 A1
(43) Pub. Date: Aug. 13, 2026

(54) USER PLANE FUNCTION DISCOVERY

(71) Applicant: Telefonaktiebolaget LM Ericsson (publ), Stockholm (SE)

(72) Inventors: Yong YANG, Kållered (SE); Qiuxiang ZHU, Säve (SE)

(73) Assignee: Telefonaktiebolaget LM Ericsson (publ), Stockholm (SE)

(21) Appl. No.: 19/156,713

(22) PCT Filed: Feb. 15, 2024
(86) PCT No.: PCT/EP2024/053849

§ 371 Date: Aug. 14, 2025

Related U.S. Application Data
(60) Provisional application No. 63/446,033, filed on Feb. 16, 2023.

(51) Int. Cl. H04L 61/5007

(52) U.S. Cl. CPC H04L 61/5007

(57) ABSTRACT

A method performed by a UPF. The method includes sending to a network repository function (NRF) a registration request comprising UPF information for the UPF, the UPF information comprising address range information specifying internet protocol (IP) addresses that can be served by the UPF. The address range information comprises: i) first address range information specifying a range of public network address translated (NATed) IP addresses that can be served by the UPF, ii) second address range information specifying a range of private PDU Session IP addresses that can be served by the UPF, and iii) third address range information specifying a range of public UE PDU Session IP address that can be served by the UPF.

### TECHNICAL FIELD

Disclosed are embodiments related to User Plane Function (UPF) discovery.

### BACKGROUND

FIG. 1 illustrates an exemplifying wireless communication system 100 represented as a 5G network architecture comprising an Access Network (AN) (e.g., a Radio AN (RAN)) and a Core network (CN) comprising network entities in the form of Network Functions (NFs). Typically, the AN comprises base stations, e.g., such as evolved Node Bs (eNBs) or 5G base stations (gNBs) or similar. As shown in FIG. 1, user equipments (UEs) connect to an AN as well as an Access and Mobility Management Function (AMF). As further shown in FIG. 1, the 5G CN NFs can include: a User Plane Function (UPF), a Network Slice Selection Function (NSSF), an Authentication Server Function (AUSF), a Unified Data Management (UDM), an Access and Mobility Management Function (AMF), a Session Management Function (SMF), a Policy Control Function (PCF), an Application Function (AF), a NF Repository Function (NRF), a Network Exposure Function (NEF), and a Network Data Analytics Function (NWDAF).

A number of 5G core network NFs of different types are typically instantiated per default in the 5G core network, e.g., such as an AMF, a NRF, a PCF and a SMF etc. Other 5G core network NFs may be instantiated as needed and several NFs of the same type can also be instantiated if required, e.g., to distribute load to additional NF(s) of the same type. Thus, an NF instance may be seen as an example or a specimen of a certain NF. Herein, the terms NF and NF instance are used interchangeably, unless otherwise expressly stated or is apparent from the context in which the terms are used. An NF instance exposes one or more NF Service Instances.

The UPF may expose information via a service-based interface (SBI) directly. For example, an NF consumer (e.g., NWDAF, AF, NEF) may receive UPF event notifications.

When the UPF supports the data exposure via the SBI interface, the UPF may register its NF profile to the NRF. The UPF's NF profile includes the supported event exposure service and related event ID(s). To get exposure data from UPF, the NF consumer subscribes to the UPF either directly or indirectly via an SMF. The NWDAF can subscribe to the UPF event exposure service directly only for the following cases: data collected for UPF load analytics and data collected for analytics targeting “any UE,” but not related with an area-of-interest (AoI) or with a specific data flow.

To minimize the impact of event notification on UPF data processing, the event subscription may include Reporting suggestion information. The Reporting suggestion information includes Report urgency and Reporting window information. Reporting urgency information represents whether this event report is delay tolerant (i.e., the event report can be delayed). When the related event is detected, the Reporting window defines the last reporting valid time. Per Reporting suggestion information UPF can concatenate several notification messages to the same notification endpoint in one notification message.

### SUMMARY

Certain challenges presently exist. For example, as noted above, a consumer of UPF event exposure (e.g., NWDAF) can subscribe to user data usage events directly to UPF or indirectly via SMF, and UPF sends the event notifications directly to this consumer, but how the consumer can subscribe to User Data Usage events directly to UPF for certain UE(s) is not currently specified and there is a potential need for certain NFs to subscribe directly to the UPF for certain UE(s).

Further, as discussed in 3GPP technical document S2-2301393, the NEF uses the Nnrf_NFDiscovery service operation to obtain the UPF address of the UPF hosting a UE (public) Internet Protocol (IP) address. The request includes the UE (public) IP address. While the “ipv4AddressRanges” and/or “ipv6PrefixRange” may be a list of private IP address or public IP address for a given S-NSSAI/DNN, it is always possible that any NF uses UE IP address together with S-NSSAI/DNN to find the serving UPF for the PDU session except for the following case: in some large operator deployment, within an APN/DNN, the private IP addresses might be further reused among UPFs serving the same APN/DNN, therefore using APN/DNN together with UE IP address (for the PDU session) is not sufficient. Accordingly, 3GPP TS 29.512 introduced a parameter (IP Domain). In such case, to find the serving UPF, the NF need also provide IP Domain associated with Private UE IP address. Another challenge that exists is that, if NAT is supported, it is possible that different UPFs may use a same public NATed IP address but different port ranges, and, in such case, to find the serving UPF via a NATed IP address by only natedIpv4AddressRanges provisioned is not sufficient.

Accordingly, in one aspect there is provided a method performed by a UPF. The method includes sending to an NRF a registration request comprising UPF information for the UPF. The UPF information comprises address range information specifying internet protocol (IP) addresses that can be served by the UPF. The address range information comprises: first address range information specifying a range of public network address translated (NATed) IP addresses that can be served by the UPF, second address range information specifying a range of private PDU Session IP addresses that can be served by the UPF, and third address range information specifying a range of public UE PDU Session IP address that can be served by the UPF.

In another aspect there is a method performed by an NRF. The method includes receiving from a first UPF a registration request comprising first UPF information for the first UPF, the first UPF information comprising address range information specifying internet protocol (IP) addresses that can be served by the UPF. The method also includes storing the first UPF information. The address range information comprises: first address range information specifying a range of public network address translated (NATed) IP addresses that can be served by the UPF, second address range information specifying a range of private PDU Session IP addresses that can be served by the UPF, and third address range information specifying a range of public UE PDU Session IP address that can be served by the UPF.

In another aspect there is provided a network node, where the network node is configured to perform any one of the methods disclosed herein. In some embodiments, the network node includes processing circuitry and a memory containing instructions executable by the processing circuitry, whereby the network node is configured to perform any one of the methods disclosed herein.

In another aspect there is provided a computer program comprising instructions which when executed by processing circuitry of a network node causes the network node to perform any one of the methods disclosed herein. In another aspect there is provided a carrier containing the computer program, wherein the carrier is one of an electronic signal, an optical signal, a radio signal, and a computer readable storage medium.

An advantage of the embodiments disclosed herein is that they enable an NF to discover a UPF for certain UE(s).

### BRIEF DESCRIPTION OF THE DRAWINGS

The accompanying drawings, which are incorporated herein and form part of the specification, illustrate various embodiments.

FIG. 1 illustrates an exemplifying wireless communication system.

FIG. 2 is a message flow diagram illustrating a message flow according to an embodiment.

FIG. 3 is a message flow diagram illustrating a message flow according to an embodiment.

FIG. 4 is a flowchart illustrating a process according to an embodiment.

FIG. 5 is a flowchart illustrating a process according to an embodiment.

FIG. 6 is a flowchart illustrating a process according to an embodiment.

FIG. 7 is a flowchart illustrating a process according to an embodiment.

FIG. 8 is a flowchart illustrating a process according to an embodiment.

FIG. 9 illustrates a network node according to an embodiment.

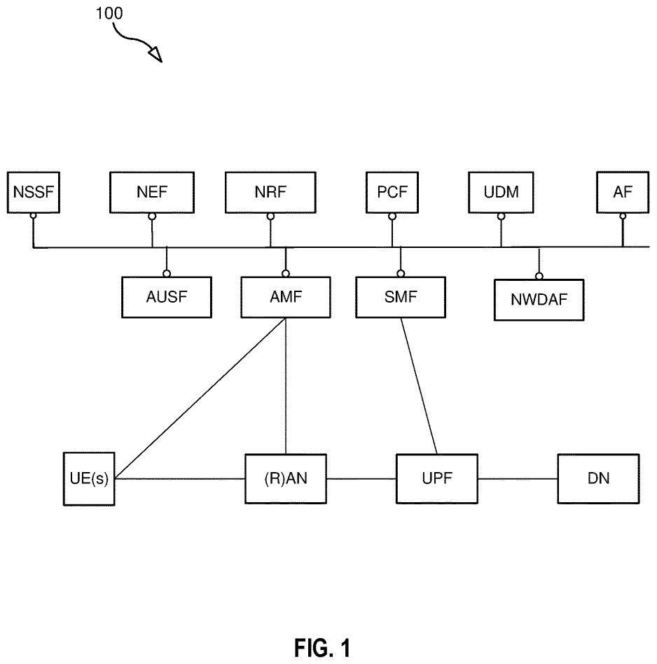

### DETAILED DESCRIPTION

Some of the embodiments contemplated herein will now be described more fully with reference to the accompanying drawings. Embodiments are provided by way of example to convey the scope of the subject matter to those skilled in the art. Additional information may also be found in the information provided in the Appendix.

This disclosure proposes mechanisms to enable an NF to discover an UPF serving one or more PDU session(s) for a certain UE. In one embodiment, the NF discovers the UPF serving the UE by using the UE's ID (e.g., Subscriber Permanent Identifier (SUPI)) to query the UDM (e.g., using the Nudm_UECM_Get service operation) to retrieve an SMF Registration IE associated with the UE's ID. In another embodiment, the NF can find the serving UPF via NRF based NF discovery using an IP address which is either by IP Domain associated with Private UE IP address, or by public NATed IP address and port ranges, or a public IP address.

In one embodiment, when an SMF registers with the UDM using Nudm_UECM_Registration (SUPI, DNN, S-NSSAI of HPLMN, PDU Session ID, SMF Identity, Serving Node PLMN ID, [NID]) for a given PDU Session, the SMF includes the UPF ID of the UPF serving the PDU Session if the UPF supports the data exposure via the SBI interface and the UE IP address (with or without IP domain). To subscribe a UPF event for a UE, the UPF event consumer (e.g. NWDAF) invokes Nudm_UECM_Get service operation to retrieve the appropriate SMF by providing UE ID, DNN, S-NSSAI and NF type=SMF. The UDM provides a Nudm_UECM_Get response with the corresponding SMF. The UPF event consumer also gets the UPF Identifier and UE IP address (with or without IP domain). The UPF event consumer can decide to contact or consume the service(s) offered by the UPF, e.g. subscribe to a UPF event directly to the UPF.

In another embodiment, it is proposed to add two new attributes to the DnnUpfInfoItem data type. These two new attributes are named: 1) privateIpv4AddressRanges and 2) privateIpv6AddressRanges. Each of these two new attributes contain an IP Address Range and an associated IP domain for the case that the private IP addresses might be further reused among UPFs serving the same APN/DNN.

In another embodiment, to support find the serving UPF via a NATed IP address it is further proposed to add another two new attributes to the DnnUpfInfoItem data type. These additional attributes are named: 1) natedIpv4AddressRanges and 2) natedIIpv6PrefixRanges. Each of these two new attributes contain a list public IP address and optionally the associated port number range (to cover the use case that different UPFs may use a same public NATed IP address but different port ranges). Additionally, to extend the use of ue-ipv4-address and ue-ipv6-prefix and to support the discovery of the serving UPF, and the NRF shall find a match by looking into either Ipv4AddressRanges, or privateIpv4AddressRanges, or natedIpv4AddressRanges in the DnnUpfInfoItem.

In another embodiment, a new query parameter is introduced. This new query parameter is named “preferred-port-number” and it identifies a particular port number. When this query parameter is included in a query, the NRF will preferably return those NF profiles where the “portNumberRange” in natedIpv4AddressRanges and natedIpv6PrefixRanges contains the port number identified by the preferred-port-number parameter.

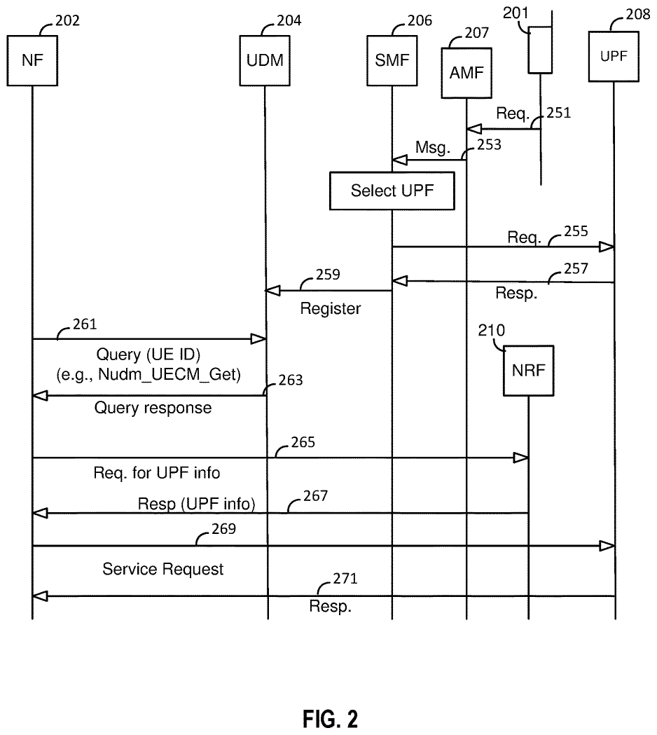

FIG. 2 is a signaling diagram illustrating an embodiment.

The signaling beings with a UE 201 sending to an AMF 207 a request 251 for establishing a new PDU session. After receiving the request, the AMF selects an SMF (which in this case is SMF 206) and transmits to the selected SMF a message 253 (e.g., a create session management (SM) context request message or an update SM context request message) that includes a UE ID for identifying UE 201 (e.g., UE 20l's Subscription Permanent Identifier (SUPI)) as well as a Data Network Name (DNN) and Single Network Slice Selection Assistance Information (S-NSSAI).

After receiving the message 253 from AMF 207, SMF 206 selects a UPF to anchor the PDU session (which in this example is UPF 208) and sends to UPF 208 a request message 255 (e.g., a PDU Session Establishment Request or a PDU Session Modification Request); UPF 208 sends to SMF 206 a response message 257 responsive to the request message. If the SMF 208 did not allocate to UE 201 an IP address (e.g., an IP version 4 (IPv4) address or IP version 6 (IPv6) prefix) for the PDU session, then the response message 257 from UPF 208 will include an IP address the UPF 208 allocated to UE 201 for the PDU session.

After communicating with the selected UPF, SMF 206 sends to a UDM 204 an SMF registration message 259 for the PDU session. The registration message 259 includes the UE ID and SMF registration data (e.g., an SMR registration information element (IE) (a.k.a., “SmfRegistration”)) for the PDU session, an example of such SMF registration data is shown in Table 1 below. For example, the registration message may be a Hypertext Transfer Protocol (HTTP) PUT message comprising i) a resource-target string that identifies a target resource of the request and that contains the UE ID and ii) a body portion that contains the SMF registration IE.

TABLE 1
SmfRegistration

| Attribute name | Data type | P | Cardinality | Description |
|---|---|---|---|---|
| smfInstanceId | NfInstanceId | M | 1 | NF Instance Id of the SMF |
| smfSetId | NfSetId | C | 0 . . . 1 | This IE shall be present if the SMF |
| | | | | belongs to a SMF SET. If present, it |
| | | | | indicates the NF Set ID of SMF Set. |
| supportedFeatures | Supported | O | 0 . . . 1 | See clause 6.2.8 These are the features |
| | Features | | | supported by the SMF. |
| pduSessionId | PduSessionId | M | 1 | PDU Session ID |
| singleNssai | Snssai | M | 1 | A single Network Slice Selection |
| | | | | Assistance Information. It shall contain |
| | | | | the HPLMN S-NSSAI of the LBO or HR |
| | | | | roaming PDU session, or the S-NSSAI in |
| | | | | the serving PLMN of the non roaming |
| | | | | PDU session. |
| dnn | Dnn | C | 0 . . . 1 | Data Network Name; shall be present if |
| | | | | emergencyServices is false or absent. |
| | | | | When present, this IE shall contain the |
| | | | | Network Identifier only. |
| emergencyServices | boolean | C | 0 . . . 1 | Indication of Emergency Services; |
| | | | | absence indicates false. |
| pcscfRestorationCallbackUri | Uri | O | 0 . . . 1 | a URI provided by the SMF to receive |
| | | | | (implicitly subscribed) notifications on the |
| | | | | need for P-CSCF Restoration |
| plmnId | PlmnId | M | 1 | Serving node PLMN identity. For a HR |
| | | | | PDU session, this IE shall include the |
| | | | | PLMN ID of the home network of the UE. |
| | | | | For a LBO PDU session, this IE shall |
| | | | | include the PLMN ID of the serving |
| | | | | network where the UE is registered from. |
| pgwFqdn | Fqdn | C | 0 . . . 1 | FQDN of the PGW in the “PGW-C + SMF”, |
| | | | | to be included for interworking with EPS. |
| pgwIpAddr | IpAddress | O | 0 . . . 1 | IP Address of the PGW in the “PGW- |
| | | | | C + SMF”, to be included for interworking |
| | | | | with EPS. |
| epdgInd | boolean | O | 0 . . . 1 | Indicate whether access is from ePDG. |
| | | | | true: access from ePDG. false or absent: |
| | | | | not access from ePDG |
| deregCallbackUri | Uri | O | 0 . . . 1 | A URI provided by the SMF to receive |
| | | | | (implicitly subscribed) notifications on |
| | | | | deregistration. The deregistration callback |
| | | | | URI shall have unique information within |
| | | | | SMF set to identify the UE to be |
| | | | | deregistered. |
| registrationReason | RegistrationReason | O | 0 . . . 1 | Indicates registration reason. |
| registrationTime | DateTime | C | 0 . . . 1 | Time of SmfRegistration. Shall be present |
| | | | | when used on Nudr. |
| contextInfo | ContextInfo | C | 0 . . . 1 | This IE if present may contain e.g. the |
| | | | | headers received by the UDM along with |
| | | | | the SmfRegistration. Shall be absent on |
| | | | | Nudm and may be present on Nudr. |
| pcfId | NfInstanceId | C | 0 . . . 1 | This IE shall be present if the SMF is |
| | | | | indicated to select the same PCF instance |
| | | | | for SM Policy Control. When present, it |
| | | | | indicates the PCF Identifier that serving |
| | | | | the PDU Session/PDN Connection. |
| dataRestorationCallbackUri | Uri | O | 0 . . . 1 | If present, it contains the URI where |
| | | | | notifications about UDR-initiated data |
| | | | | restoration shall be sent by UDM. |
| resetIds | array(string) | O | 1 . . . N | May be present in registration response |
| | | | | messages. The SMF may decide to re- |
| | | | | register at the UDM when receiving a data |
| | | | | restoration notification containing a |
| | | | | matching resetId. |
| udrRestartInd | boolean | O | 0 . . . 1 | May be present in request messages from |
| | | | | the SMF to the UDM. If present: - true: |
| | | | | indicates that the registration message |
| | | | | sent by the SMF is due to a re- |
| | | | | synchronization event, motivated by a |
| | | | | previous reception at the SMF of a Data |
| | | | | Restoration Notification from the UDM. - |
| | | | | false (or absent): indicates that this is a |
| | | | | normal registration message (i.e., not |
| | | | | motivated by a data restoration |
| | | | | notification event) |
| lastSynchronizationTime | DateTime | O | 0 . . . 1 | This IE is only applicable to the Nudm API |
| | | | | and shall not be used on the Nudr API. It |
| | | | | may only be included when |
| | | | | “udrRestartInd” attribute is present and |
| | | | | set to true. When present, it contains the |
| | | | | timestamp (previously stored by SMF |
| | | | | locally, after successful registration at |
| | | | | UDM) when profiles in the SMF and in |
| | | | | UDM/UDR were synchronized. |
| pduSessionReActivationRequired | boolean | C | 0 . . . 1 | This IE is only applicable to Nudr interface |
| | | | | and shall not be included over the Nudm |
| | | | | interface. This attribute may be included |
| | | | | in notifications sent by the UDR to the |
| | | | | UDM. When Nudr Data Change |
| | | | | Notification is received including this |
| | | | | attribute set to true, the UDM uses |
| | | | | “PDU_SESSION_REACTIVATION_REQUIRED” |
| | | | | as DeregistrationReason towards |
| | | | | SMF. In this case, the SMF shall trigger a |
| | | | | network-initiated PDU session release |
| | | | | procedure (see clause 4.3.4 of |
| | | | | 3GPP TS 23.502) with 5GSM cause |
| | | | | “Reactivation requested” (see |
| | | | | clause 8.3.14 of 3GPP TS 24.501). |
| | | | | Absence of this IE shall be interpreted as |
| | | | | false. |
| ueIpAddress | IpAddress | O | 0 . . . 1 | The IE may be present to enable a NF |
| | | | | consumer to get the PDU Session IP |
| | | | | Address when it attempts to retrieve the |
| | | | | serving SMF for a PDU session. |
| upfInstanceId | NfInstanceId | O | 0 . . . 1 | This IE may be present to enable the NF |
| | | | | consumer to get the serving PDU Session |
| | | | | Anchor (PSA) UPF when it attempts to |
| | | | | retrieve the serving SMF for a PDU |
| | | | | session. When present, it shall contain |
| | | | | the PSA UPF Instance ID. |

As shown in Table 1, the SMF registration IE may include: 1) an “ueIpAddress” attribute-value-pair that contain an IP address allocated to a UE and 2) an “upfinstanceId” attribute-value-pair that contains the ID of a UPF serving the UE. In one embodiment, either the SMF or the UPF allocated the IP address to the UE.

In the example shown in FIG. 2, NF 202, which in this example may be a UPF event consumer (e.g., NWDAF), desires to communicate with the UPF that is handling the PDU session for UE 201 (i.e., UPF 208), but NF 202 does not know the identity or IP address of UPF 208. Accordingly, to obtain the identity of the UPF instance handling the PDU session for UE 201, NF 202 sends to UDM 204 a query message 261 (e.g., invokes the Nudm_UECM_Get service operation) containing the UE ID for UE 201 (e.g., UE 20l's SUPI) as one of the query parameters. The query message may also include a data network name (DNN), Single Network Slice Selection Assistance Information (S-NSSAI), and an NF type identifier set to “SMF.”

UDM 204 responds to the query by using the UE ID query parameter to retrieve SMF registration data linked to the UE ID (e.g., the above mentioned SMF registration IE for the PDU session and possibly other SMF registration IEs for other PDU sessions established for the UE) and sending to NF 202 a query response 263 (e.g., Nudm_UECM_Get response) with the retrieved SMF registration data (e.g., the SMF registration IE that SMF 206 provided to UDM 204). As noted above, the SMF registration IE may include a UPF ID that identifies the UPF instance (i.e., UPF 208) serving the UE identified by the UE ID and/or IP address allocated to UE 201 (with or without IP domain).

After obtaining the UPF ID or UE IP address from the query response, NF 202 uses the obtained UPF ID or IP address to obtain the IP address of UPF 208. For example, as shown in FIG. 2, NF 202 sends to NRF 210 a request 265 indicating that the NF 202 is seeking to obtain UPF information (e.g., profile for a particular UPF instance) where the request includes the UPF ID or IP address obtained from UDM 204, and NF 210 responds to the request by sending to NF 202 a response message 267 containing the requested UPF information—i.e., UPF information (e.g., a UPF profile or UPF IP address) associated with the UPF ID or IP address.

After obtaining the IP address for UPF 208, NF 202 can send a message to UPF 208. In this example, NF 202 sends a service request message 269 to UPF 208 and UPF 208 responds by transmitting to NF 202 a service response message 271. In one example, the service request may be a request to subscribe to an event exposure service which causes UPF 208 to send to NF 202 a notification when an event specified in the request is detected by UPF 208. After UPF 208 detects the occurrence of such an event to which NF 202 has subscribed via the service request message, UPF 208 sends to NF 202 a notification message containing notification data, such as a notification item as defined in 3GPP TS 29.544 V18.0.0. In this manner, a consumer of UPF event exposure such as NWDAF can subscribe to User Data Usage events directly to the UPF for a specific, certain UE.

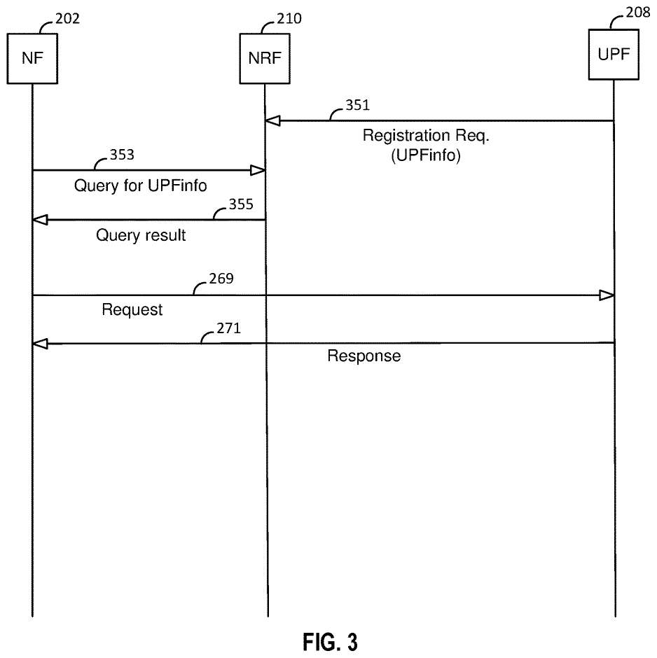

FIG. 3 is a message flow diagram illustrating a message flow according to another embodiment for enabling NF 202 to discover the UPF handing UE 20l's PDU session. This message flow begins with UPF 208 sending to NRF 210 a registration request 351 (e.g., Nnrf_NFManagement_NFRegister_request) comprising UPF information regarding UPF 208 (e.g., an extended version of a DnnUpfInfoItem IE). In response to receiving the registration request, NRF 210 stores the received UPF information.

In this embodiment, the UPF information regarding UPF 208 may include: 1) at least one private IPv4 address range (and optionally IPv4 address domain identifier); 2) at least one private IPv6 address range (and optionally IPv6 address domain identifier); 3) at least one public IPv4 address range (and optionally a port number); and/or 4) at least one public IPv6 address range (an optionally a port number).

Table 2 below shows at least some of the UPF information that may be included in the registration request transmitted by UPF 208.

TABLE 2
UPF Information

| Attribute name | Data type | P | Cardinality | Description |
|---|---|---|---|---|
| dnn | Dnn | M | 1 | Supported DNN. The DNN shall contain |
| | | | | the Network Identifier and it may |
| | | | | additionally contain an Operator Identifier. |
| | | | | If the Operator Identifier is not included, the |
| | | | | DNN is supported for all the PLMNs in the |
| | | | | plmnList of the NF Profile. |
| dnaiList | array(Dnai) | O | 1 . . . N | List of Data network access identifiers |
| | | | | supported by the UPF for this DNN. The |
| | | | | absence of this attribute indicates that the |
| | | | | UPF can be selected for this DNN for any |
| | | | | DNAI. |
| pduSessionTypes | array(PduSessionType) | O | 1 . . . N | List of PDU session type(s) supported by |
| | | | | the UPF for a specific DNN. The absence |
| | | | | of this attribute indicates that the UPF can |
| | | | | be selected for this DNN for any PDU |
| | | | | session type supported by the UPF (see |
| | | | | clause 6.1.6.2.13). |
| ipv4AddressRanges | array(Ipv4AddressRange) | O | 1 . . . N | List of ranges of IPv4 addresses handled |
| | | | | by UPF. (NOTE 1) (NOTE X) |
| ipv6PrefixRanges | array(Ipv6PrefixRange) | O | 1 . . . N | List of ranges of IPv6 prefixes handled by |
| | | | | the UPF. (NOTE 1) (NOTE X) |
| privateIpv4AddressRanges | map(PrivateIpv4AddressRange) | O | 1 . . . N | List of ranges of Private IPv4 addresses |
| | | | | together with associated IP domains e.g. |
| | | | | for the case when the private IP addresses |
| | | | | are further reused among UPFs serving |
| | | | | the same APN/DNN. (NOTE X) |
| | | | | The key of the map shall be a (unique) |
| | | | | valid JSON string per clause 7 of |
| | | | | IETF RFC 8259, with a maximum of 32 |
| | | | | characters. |
| privateIpv6AddressRanges | map(PrivateIpv6AddressRange) | O | 1 . . . N | List of ranges of Private IPv6 addresses |
| | | | | together with associated IP Domains e.g. |
| | | | | for the case when the private IP addresses |
| | | | | are further reused among UPFs serving |
| | | | | the same APN/DNN. (NOTE X) |
| | | | | The key of the map shall be a (unique) |
| | | | | valid JSON string per clause 7 of |
| | | | | IETF RFC 8259, with a maximum of 32 |
| | | | | characters. |
| natedIpv4AddressRanges | map(NatedIpv4AddressRange) | O | 1 . . . N | List of ranges of NATed Public IPv4 |
| | | | | addresses together with associated a |
| | | | | range of port numbers. |
| | | | | The key of the map shall be a (unique) |
| | | | | valid JSON string per clause 7 of |
| | | | | IETF RFC 8259, with a maximum of 32 |
| | | | | characters. |
| natedIpv6PrefixRanges | map(NatedIpv6prefixRange) | O | 1 . . . N | List of ranges of NATed Public IPv6 |
| | | | | prefixes together with associated a range |
| | | | | of port numbers. |
| | | | | The key of the map shall be a (unique) |
| | | | | valid JSON string per clause 7 of |
| | | | | IETF RFC 8259, with a maximum of 32 |
| | | | | characters. |
| ipv4IndexList | array(IpIndex) | O | 1 . . . N | List of Ipv4 Index supported by the UPF. |
| | | | | (NOTE 3) |
| ipv6IndexList | array(IpIndex) | O | 1 . . . N | List of Ipv6 Index supported by the UPF. |
| | | | | (NOTE 3) |
| networkInstance | string | O | 0 . . . 1 | The N6 Network Instance (See |
| | | | | 3GPP TS 29.244) associated with the S- |
| | | | | NSSAI and DNN. |
| | | | | (NOTE 4) |
| dnaiNwInstanceList | map(string) | O | 1 . . . N | Map of a network instance per DNAI for the |
| | | | | DNN, where the key of the map is the |
| | | | | DNAI. |
| | | | | When present, the value of each entry of |
| | | | | the map shall contain a N6 network |
| | | | | instance that is configured for the DNAI |
| | | | | indicated by the key. |
| | | | | (NOTE 2) |

NOTE 1:
The list of ranges of IPv4/v6 address may be used by the SMF to select a UPF which supports a UE static IP address received in user subscription, or when the UE IP address is to be allocated by an external server, e.g. AAA/Radius Server.
NOTE 2:
This IE may be used by the SMF to determine the Network Instance associated to a given S-NSSAI, DNN and DNAI. If this IE is not present, the SMF needs to be configured with corresponding information.
NOTE 3:
The list of IPv4/v6 Indexes may be used by the SMF to select a UPF which supports a specific IP Index received from the UDM or the PCF for a UE's PDU session.
NOTE 4:
The networkInstance IE and the dnaiNwInstanceList shall not be present simutanously. The networkInstance IE may be used by the SMF to determine the Network Instance associated to a given S-NSSAI and DNN where DNAI(s) are not configured, i.e. the dnaiNwInstanceList is not present. If this IE is not present and the dnaiNwInstanceList is also not present, the SMF needs to be configured with corresponding information. A network instance can be associated with multiple network slices if the UP function supports the “Per Slice UP Resource Management” feature as specified in clause 5.35.1 of 3GPP TS 29.244.
NOTE X:
The “ipv4AddressRanges” and/or “ipv6PrefixRange” and/or “privateIpv4AddressRanges” and/or “privateIpv6AddressRanges” describe the range of the PDU sessions addresses which can be served by the UPF for a given S-NSSAI and/or DNN.

The data types PrivateIpv4AddressRange, PrivateIpv6AddressRange, NatedIpv4AddressRange, and NatedIpv6AddressRange are defined in the tables below.

TABLE 3
Definition of type PrivateIpv4AddressRange

| Attribute name | Data type | P | Cardinality | Description |
|---|---|---|---|---|
| ipv4AddressRange | Ipv4AddressRange | M | 1 | One IPv4 Address Range |
| ipDomain | string | O | 0 . . . 1 | IPv4 address domain identifier. |

TABLE 4
Definition of type PrivateIpv6AddressRange

| Attribute name | Data type | P | Cardinality | Description |
|---|---|---|---|---|
| Ipv6AddressRange | Ipv6AddressRange | M | 1 | One IPv6 Address Range |
| ipDomain | string | O | 0 . . . 1 | IPv6 address domain identifier. |

TABLE 5
Definition of type NatedIpv4AddressRange

| Attribute name | Data type | P | Cardinality | Description |
|---|---|---|---|---|
| natedIpv4AddressRange | Ipv4AddressRange | M | 1 | One IPv4 Address Range |
| portNumber | integer | O | 0 . . . 1 | Port number with the range 0 |
| | | | | to 65535. This attribute may |
| | | | | be present when Port |
| | | | | Address Translation is used |
| | | | | for NAT. |

TABLE 6
Definition of type NatedIpv6 PrefixRange

| Attribute name | Data type | P | Cardinality | Description |
|---|---|---|---|---|
| natedIpv6prefixRange | Ipv6prefixRange | M | 1 | List of ranges of IPv4 |
| | | | | addresses handled by UPF |
| | | | | associated with the IP Index. |
| | | | | (NOTE) |
| portNumber | integer | O | 0 . . . 1 | Port number with the range 0 |
| | | | | to 65535. This attribute may |
| | | | | be present when Port |
| | | | | Address Translation is used |
| | | | | for NAT. |

NOTE:
At most one occurrence of either ipv4AddressRange or ipv6PrefixRanges shall be present.

After NRF 210 stores the UPF information for UPF 208, NRF 210 may receive from NF 202 a query 353 comprising query parameters (a.k.a., filter criterions). In one embodiment, some of the available filter criterions are listed and described in Table 7 below. The default logical relationship among the query parameters is logical “AND”, i.e. all the provided query parameters shall be matched, with certain exceptions. The NRF may support the Complex query expression as defined in 3GPP TS 29.501 for the NF Discovery service. If the “complexQuery” query parameter is included, then the logical relationship among the query parameters contained in “complexQuery” query parameter is as defined in 3GPP TS 29.571. A NRF not supporting Complex query expression shall reject a NF service discovery request including a complexQuery parameter, with a ProblemDetails IE including the cause attribute set to INVALID_QUERY_PARAM and the invalidParams attribute indicating the complexQuery parameter.

In one embodiment, NRF 210 is configured such that if the query is for UPF information (e.g., target-nf-type is set to UPF) and one of the filter criterions is an IP address (e.g., an IPv4 address or an IPv6 prefix), then the NRF shall find a match by looking into either Ipv4AddressRanges, or privateIpv4AddressRanges, or natedIpv4AddressRanges in the DnnUpfInfoItem. Also, if the preferred-port-number filter criterion is present, the NRF will preferably return those UPF profiles where the “portNumberRange” in natedIpv4AddressRanges and natedIpv6PrefixRanges contains the port number specified in the filter criterion. Also, if the query is for UPF information, one of the filter criterions is an IPv4 address, and one of the filter criterions is an IPv4 domain, then the NRF shall find a match by looking into privateIpv4AddressRanges in the DnnUpfInfoItem.

After performing a search of the stored DnnUpfInfoItems, NRF 210 transmits to NF 202 a query result message 355 comprising the search results, which search results may include a IP address of a UPF having a UPF profile matching the query. For example, the search result may include the matching UPF profile which includes the IP address of the UPF. After NF 202 obtains the matching UPF profile from NRF 210, NF 202 can send the above described service request 269 to the UPF to which the profile belongs, such as a subscription request as described above, or the NF may consume another service offered by the UPF (e.g. Nupf_GetPrivateUEIP_Get to retrieve UE's private address). After transmitting the request to the UPF, NF 202 receives a response 271 transmitted by the UPF (e.g., if the request was for the UE's private address, the response will include the UE's private address).

In one embodiment, NF 202 obtain the IP address included in the query 353 using the process shown in FIG. 2. That is, in one embodiment, NF 202 obtains the IP address by sending to the UDM the query 261 containing the UE ID and receiving from the UDM the query response 262 containing the SMF registration information which may include the IP address allocated to the UE identified by the UE ID.

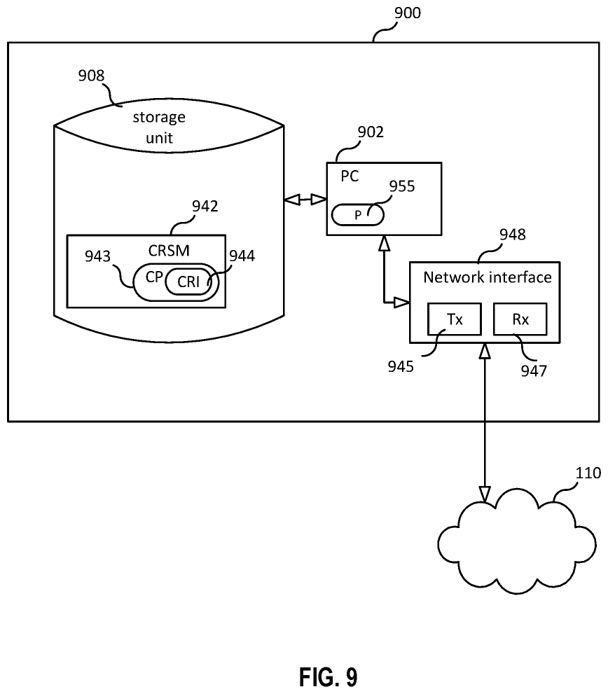

FIG. 9 is a block diagram of a network node 900, according to some embodiments, which can be used to implement any of the network functions (NFs) disclosed herein (e.g., AF, NEF, PCF, SMF, UPF). For instance, in embodiments where an NF consists of software, network node 900 may run (or execute a virtual machine that runs) the NF. As shown in FIG. 9, network node 900 may comprise: processing circuitry (PC) 902, which may include one or more processors (P) 955 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., network node 900 may be a distributed computing apparatus); at least one network interface 948 (e.g., a physical interface or air interface) comprising a transmitter (Tx) 945 and a receiver (Rx) 947 for enabling network node 900 to transmit data to and receive data from other nodes connected to a network 110 (e.g., an Internet Protocol (IP) network) to which network interface 948 is connected (physically or wirelessly) (e.g., network interface 948 may be coupled to an antenna arrangement comprising one or more antennas for enabling network node 900 to wirelessly transmit/receive data); and a storage unit (a.k.a., “data storage system”) 908, which may include one or more non-volatile storage devices and/or one or more volatile storage devices. In embodiments where PC 902 includes a programmable processor, a computer readable storage medium (CRSM) 942 may be provided. CRSM 942 may store a computer program (CP) 943 comprising computer readable instructions (CRI) 944. CRSM 942 may be a non-transitory computer readable medium, such as, magnetic media (e.g., a hard disk), optical media, memory devices (e.g., random access memory, flash memory), and the like. In some embodiments, the CRI 944 of computer program 943 is configured such that when executed by PC 902, the CRI causes network node 900 to perform steps described herein (e.g., steps described herein with reference to the flow charts). In other embodiments, network node 900 may be configured to perform steps described herein without the need for code. That is, for example, PC 902 may consist merely of one or more ASICs. Hence, the features of the embodiments described herein may be implemented in hardware and/or software.

### SUMMARY OF VARIOUS EMBODIMENTS

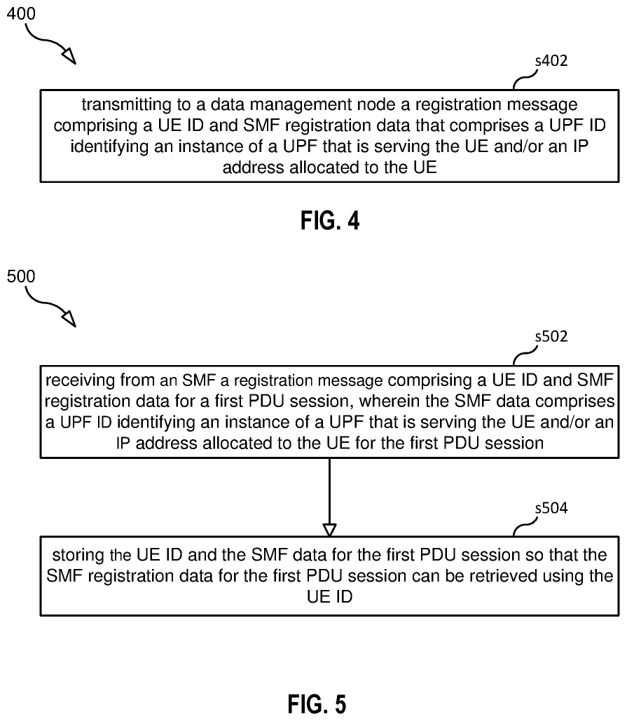

A1. A method 400 (see FIG. 4) performed by a Session Management Function, SMF (206), comprising: transmitting (step s402) to a data management node (204) a registration message (259) comprising a user equipment, UE, identifier, ID, and SMF registration data that comprises a user plane function, UPF, ID identifying an instance of a UPF that is serving the UE (e.g., anchoring one of the UE's PDU sessions) and/or an internet protocol, IP, address allocated to the UE.

B1. A method 500 (see FIG. 5) performed by a data management node (204), comprising: receiving (step s502) from a session management function (206) a registration message (259) comprising a user equipment, UE, identifier, ID, and SMF registration data for a first PDU session, wherein the SMF data comprises a user plane function, UPF, ID identifying an instance of a UPF that is serving the UE (e.g., anchoring the first PDU session) and/or an internet protocol, IP, address allocated to the UE for the first PDU session; and storing (step s504) the UE ID and the SMF data for the first PDU session so that the SMF registration data for the first PDU session can be retrieved using the UE ID.

B2. The method of embodiment B1, further comprising: receiving from a network function, NF, (202) a query message (261) comprising the UE ID; and in response to receiving the query message (261), using the UE ID to retrieve at least the SMF registration data for the first PDU session; and transmitting to the NF a query response (263) comprising the SMF registration data for the first PDU session or certain information elements thereof.

B3. The method of embodiment B2, wherein the data management node retrieves not only the SMF registration IE for the first PDU session but also another SMF registration IE for a second PDU session established for the UE, and the query response further comprises the SMF registration IE for the second PDU session or certain information elements thereof.

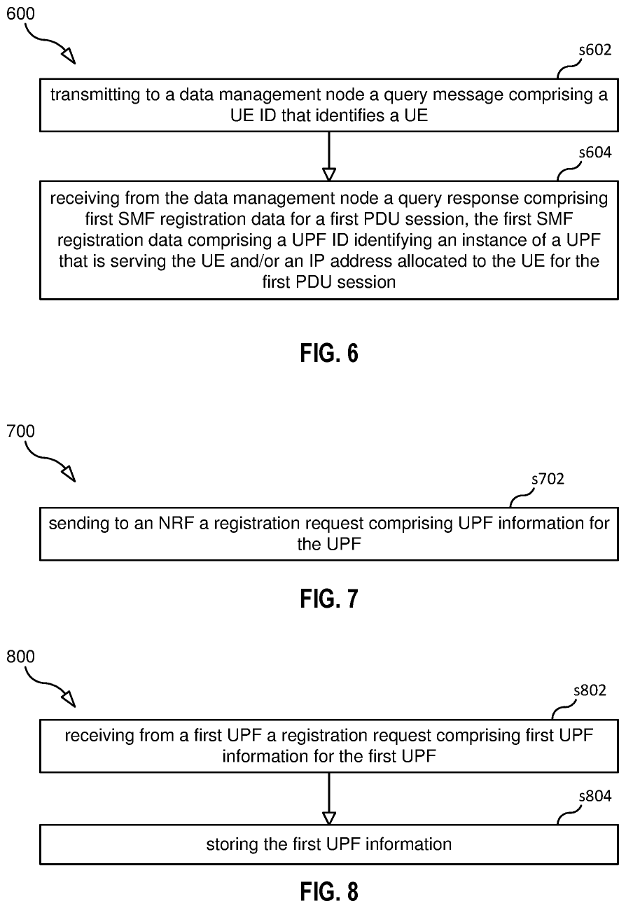

C1. A method 600 (see FIG. 6) performed by a network function (202), comprising: transmitting (step s602) to a data management node (204) a query message (261) comprising a user equipment, UE, identifier, ID, that identifies a UE; and receiving (step s604) from the data management node a query response (263) comprising first Session Management Function, SMF, registration data for a first PDU session, the first SMF registration data comprising a user plane function, UPF, ID identifying an instance of a UPF that is serving the UE (e.g., anchoring the first PDU session) and/or an internet protocol, IP, address allocated to the UE for the first PDU session.

C2. The method of embodiment C1, wherein the SMF registration data comprises the UPF ID, and the method further comprises: using the UPF ID to retrieve, via a service discovery procedure, a profile associated with the UPF ID; obtaining from the profile endpoint address information of the instance of the UPF identified by the UPF ID; and using the endpoint address information to send to the instance of the UPF serving the UE a service request pertaining to the UE (e.g., an event subscription request message to subscribe to an event pertaining to the UE).

C3. The method of embodiment C1, wherein the SMF registration data comprises the IP address allocated to the UE, and the method further comprises: using the IP address to retrieve, via a service discovery procedure, a profile associated with a UPF serving the IP address; obtaining from the profile endpoint address information of the UPF serving the IP address; and using the endpoint address information to send to the UPF a service request pertaining to the UE (e.g., an event subscription request message to subscribe to an event pertaining to the UE).

D1. A method 700 (see FIG. 7) performed by a user plane function, UPF, the method comprising: sending (step s702) to a network repository function, NRF, a registration request (351) comprising UPF information for the UPF, wherein the UPF information specifies: a first range of private IP addresses and a first IP address domain identifier associated with the first range of private IP addresses; and/or a first range of public IP addresses and a first port number associated with the first range of public IP addresses.

E1. A method 800 (see FIG. 8) performed by a network repository function, NRF, the method comprising: receiving (step s802), from a first user plane function, UPF, a registration request (351) comprising first UPF information for the first UPF, wherein the first UPF information specifies: a first range of private IP addresses and a first IP address domain identifier associated with the first range of private IP addresses; and/or a first range of public IP addresses and a first port number associated with the first range of public IP addresses; and storing (step s804) the first UPF information.

E2. The method of embodiment D1 or E1, wherein the first UPF information specifies: the first range of private IP addresses and the first IP address domain identifier; and the first range of public IP addresses and the first port number associated with the first range of public IP addresses.

E3. The method of embodiment D1 or E1, wherein the first UPF information specifies the first range of public IP addresses and the first port number associated with the first range of public IP addresses.

E4. The method of any one embodiments E1-E3, further comprising: receiving, from a network function, NF, a query (353) for discovering a UPF that matches the query, wherein the query includes a first filter criterion that specifies an IP address; and in response to receiving the query, using the first filter criterion to determine whether the first UPF information matches the query.

E5. The method of embodiment E4, wherein using the first filter criterion to determine whether the first UPF information matches the query comprises: determining whether the IP address specified by the first filter criterion is within the first range of private IP addresses and/or determining whether the IP address is within the first range of public IP addresses.

E6. The method of embodiment E4 or E5, wherein the query further comprises a second filter criterion that specifies a port number.

E7. The method of embodiment E6, wherein the NRF is configured to preferably return a UPF profile matching the IP address specified by the first filter criterion and the port number specified by the second filter criterion, and, if no such profile is maintained by the NRF, then the NRF is configured to return a UPF profile matching the IP address specified by the first filter criterion.

E8. The method of embodiment E6, wherein the first UPF information specifies the first range of public IP addresses and the first port number associated with the first range of public IP addresses, and the method further comprises using the second filter criterion to determine whether the first UPF information matches the query, wherein using the second filter criterion to determine whether the first UPF information matches the query comprises determining whether the port number specified by the second filter criterion matches the first port number.

E9. The method of embodiment E1, further comprising: receiving, from a second UPF, a registration request comprising second UPF information for the second UPF, wherein the second UPF information specifies a second range of public IP addresses but does not specify any port number associated with the second range of public IP addresses; storing the second UPF information; receiving, from a network function, NF, a query (353) for discovering a UPF that matches the query, wherein the query includes a first filter criterion that specifies an IP address and a second filter criterion that specifies a port number; determining that the second UPF information matches the query as a result of determining that: i) the second range of public IP addresses includes the IP address specified by the first filter criterion and ii) no other UPF information maintained by the NRF specifies a range of public IP addresses that includes the IP address specified by the first filter criterion.

E10. The method of embodiment E1, further comprising: receiving, from a network function, NF, a query (353) for discovering a UPF that matches the query, wherein the query includes a first filter criterion that specifies a private IP address and a second filter criterion that specifies an IP domain identifier; and in response to receiving the query, using the first filter criterion and the second filter criterion to determine whether the first UPF information matches the query, wherein using the first filter criterion and the second filter criterion to determine whether the first UPF information matches the query comprises: determining whether the specified private IP address is within the first range of private IP addresses; and determining whether the specified IP domain identifier matches the first IP domain identifier.

F1. A method 700 (see FIG. 7) performed by a user plane function, UPF, the method comprising: sending (step s702) to a network repository function, NRF, a registration request (351) comprising UPF information for the UPF, the UPF information comprising address range information specifying internet protocol (IP) addresses that can be served by the UPF, wherein the address range information comprises: first address range information specifying a range of public network address translated (NATed) IP addresses that can be served by the UPF, second address range information specifying a range of private PDU Session IP addresses that can be served by the UPF, and third address range information specifying a range of public UE PDU Session IP address that can be served by the UPF.

F2. The method of claim A1, wherein the UPF information further specifies one or more port numbers associated with the first range of NATed IP addresses.

G1. A method 800 (see FIG. 8) performed by a network repository function, NRF, the method comprising: receiving (step s802), from a first user plane function, UPF, a registration request (351) comprising first UPF information for the first UPF, the first UPF information comprising address range information specifying internet protocol (IP) addresses that can be served by the UPF; and storing (step s804) the first UPF information, wherein the address range information comprises: first address range information specifying a range of public network address translated (NATed) IP addresses that can be served by the UPF, second address range information specifying a range of private PDU Session IP addresses that can be served by the UPF, and third address range information specifying a range of public UE PDU Session IP address that can be served by the UPF.

G2. The method of claim G1, wherein the UPF information further specifies one or more port numbers associated with the first range of NATed IP addresses.

G3. The method of any one claims G1-G2, wherein the method further comprises: receiving, from a network function, NF, a query (353) for discovering a UPF that matches the query, wherein the query includes a first filter criterion that specifies an IP address; and in response to receiving the query, using the first filter criterion to determine whether the first UPF information matches the query.

G4. The method of claim G3, wherein using the first filter criterion to determine whether the first UPF information matches the query comprises: determining whether the IP address specified by the first filter criterion is within the range of NATed IP addresses.

G5. The method of claim G3 or G4, wherein the query further comprises a second filter criterion that specifies a port number.

G6. The method of claim G5, wherein the NRF is configured to preferably return a UPF profile matching the IP address specified by the first filter criterion and the port number specified by the second filter criterion, and, if no such profile is maintained by the NRF, then the NRF is configured to return a UPF profile matching the IP address specified by the first filter criterion.

G7. The method of claim G5, wherein the method further comprises using the second filter criterion to determine whether the first UPF information matches the query, wherein using the second filter criterion to determine whether the first UPF information matches the query comprises determining whether the port number specified by the second filter criterion falls within a port number range associated with the first range of NATed IP addresses.

G8. The method of any one of claims G1-G7, wherein using the first filter criterion to determine whether the first UPF information matches the query comprises: determining whether the IP address specified by the first filter criterion is within the range of private PDU session IP addresses.

G9. The method of any one of claims G1-G8, wherein using the first filter criterion to determine whether the first UPF information matches the query comprises: determining whether the IP address specified by the first filter criterion is within the range of public PDU session IP addresses.

G10. The method of claim G1, further comprising: receiving, from a second UPF, a registration request comprising second UPF information for the second UPF, wherein the second UPF information includes second address range information specifying a second range of public IP addresses; storing the second UPF information; receiving, from a network function, NF, a query (353) for discovering a UPF that matches the query, wherein the query includes a first filter criterion that specifies an IP address; determining that the second UPF information matches the query as a result of determining that: i) the second range of public IP addresses includes the IP address specified by the first filter criterion and ii) no other UPF information maintained by the NRF specifies a range of public IP addresses that includes the IP address specified by the first filter criterion.

H1. A computer program (943) comprising instructions (944) which when executed by processing circuitry (955) of a network node (900) causes the network node to perform the method of any one of the above embodiments.

H2. A carrier containing the computer program of embodiment H1, wherein the carrier is one of an electronic signal, an optical signal, a radio signal, and a computer readable storage medium (942).

H1. A network node (900), where the network node is configured to perform the method any one of above method embodiments.

I1. A network node (900), wherein the network node includes processing circuitry (955) and a memory (942) containing instructions (944) executable by the processing circuitry, whereby the network node is configured to perform the method any one of the above method embodiments.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

The term “transmit to” means “transmit directly or indirectly to.” Accordingly, transmitting a message to a node encompasses transmitting the message directly to the node or transmitting the message indirectly to the node such that the message is relayed to the node via one or more intermediate nodes. Similarly, the term “receive from” means “receive directly or indirectly from.” Accordingly, receiving a message from a node encompasses receiving the message directly from the node or receiving the message indirectly from node such that the message is relayed from the sender to the node via one or more intermediate nodes. The term “a” means “at least one” or “one or more” unless expressly indicated otherwise or the context in which “a” is used clearly indicates otherwise.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

TABLE 7
Query Parameters Supported

| Name | Data type | P | Cardinality | Description | Applicability |
|---|---|---|---|---|---|
| target-nf- | NFType | M | 1 | This IE shall contain the NF type of the target NF being | |
| type | | | | discovered. | |
| requester- | NFType | M | 1 | This IE shall contain the NF type of the Requester NF | |
| nf-type | | | | that is invoking the Nnrf_NFDiscovery service. | |
| . . . | . . . | . . . | . . . | . . . | |
| ue-ipv4- | Ipv4Addr | O | 0 . . . 1 | The IPv4 address of the UE for which a BSF or P-CSCF or | |
| address | | | | UPF needs to be discovered. (NOTE X) | |
| ip-domain | string | O | 0 . . . 1 | The IPv4 address domain of the UE for which a BSF or | |
| | | | | UPF needs to be discovered. (NOTE X) | |
| ue-ipv6- | Ipv6Prefix | O | 0 . . . 1 | The IPv6 prefix of the UE for which a BSF or P-CSCF or | |
| prefix | | | | UPF needs to be discovered. (NOTE X) | |
| preferred- | integer | O | 0 . . . 1 | The Port number together with a Public UE IP address | Query- |
| port- | | | | to be used to discover the serving UPF. | SBIProtoc18 |
| number | | | | When present, the NRF shall prefer to return those | |
| | | | | UPFs with the NF profile where the port numbers | |
| | | | | included in the data type NatedIpv4AddressRange or | |
| | | | | NatedIpv6PrefixRange contains the port number in | |
| | | | | query. | |

NOTE X:
The query “ue-ipv4-address” or “ue-ipv6-prefix” may contain a private or a public IP address for a PDU session. If the “ue-ipv4-address” contains a private IPv4 address, it may be used together with ip-domain. When using ue-ipv4-address or ue-ipv6-prefix without ip-domain or port-number, the NRF shall find a match by looking into either Ipv4AddressRanges, or privateIpv4AddressRanges, or natedIpv4AddressRanges in the DnnUpfInfoItem, or Ipv6PrefixRanges or natedIpv6PrefixRanges. In one embodiment, when using ue-ipv4-address with ip-domain, the NRF shall find a match by looking into the privateIpv4AddressRanges in the DnnUpfInfoItem.

1. A method performed by a user plane function (UPF), the method comprising:
sending to a network repository function (NRF) a registration request comprising UPF information for the UPF, the UPF information comprising address range information specifying internet protocol (IP) addresses that can be served by the UPF, wherein the address range information comprises:
first address range information specifying a range of public network address translated (NATed) IP addresses that can be served by the UPF,
second address range information specifying a range of private PDU Session IP addresses that can be served by the UPF, and
third address range information specifying a range of public UE PDU Session IP address that can be served by the UPF.

2. The method of claim 1, wherein the UPF information further specifies one or more port numbers associated with the first range of NATed IP addresses.

3. The method of claim 1, wherein the UPF information further specifies a domain identifier associated with the range of private PDU Session IP addresses.

4. The method of claim 3, wherein
the UPF information comprises a private address range information element, IE, and
the private address range IE comprises: i) the second address range information specifying the range of private PDU Session IP addresses and ii) the domain identifier.

5. A method performed by a network repository function (NRF), the method comprising:
receiving, from a first user plane function (UPF) a registration request comprising first UPF information for the first UPF, the first UPF information comprising address range information specifying internet protocol (IP) addresses that can be served by the first UPF; and
storing the first UPF information, wherein the address range information comprises:
first address range information specifying a range of public network address translated (NATed) IP addresses that can be served by the first UPF,
second address range information specifying a range of private PDU Session IP addresses that can be served by the first UPF, and
third address range information specifying a range of public UE PDU Session IP address that can be served by the first UPF.

6. The method of claim 5, wherein the UPF information further specifies a domain identifier associated with the range of private PDU Session IP addresses.

7. The method of claim 6, wherein
the UPF information comprises a private address range information element, IE, and
the private address range IE comprises: i) the second address range information specifying the range of private PDU Session IP addresses and ii) the domain identifier.

8. The method of claim 5, wherein the first UPF information further specifies one or more port numbers associated with the range of public NATed IP addresses.

9. The method of claim 5, wherein the method further comprises:
receiving, from a network function, NF, a query for discovering a UPF that matches the query, wherein the query includes a first filter criterion that specifies an IP address; and
in response to receiving the query, using the first filter criterion to determine whether the first UPF information matches the query.

10. The method of claim 9, wherein using the first filter criterion to determine whether the first UPF information matches the query comprises:
determining whether the IP address specified by the first filter criterion is within the range of public NATed IP addresses that can be served by the first UPF.

11. The method of claim 9, wherein the query further comprises a second filter criterion that specifies a port number.

12. The method of claim 11, wherein the NRF is configured to preferably return a UPF profile matching the IP address specified by the first filter criterion and the port number specified by the second filter criterion, and, if no such profile is maintained by the NRF, then the NRF is configured to return a UPF profile matching the IP address specified by the first filter criterion.

13. The method of claim 11, wherein
the method further comprises using the second filter criterion to determine whether the first UPF information matches the query, wherein using the second filter criterion to determine whether the first UPF information matches the query comprises determining whether the port number specified by the second filter criterion falls within a port number range associated with the range of NATed IP addresses that can be served by the first UPF.

14. The method of claim 9, wherein using the first filter criterion to determine whether the first UPF information matches the query comprises:
determining whether the IP address specified by the first filter criterion is within the range of private PDU session IP addresses that can be served by the first UPF.

15. The method of claim 14, wherein
the first UPF information further specifies a domain identifier associated with the range of private PDU Session IP addresses,
the query further comprises a second filter criterion that specifies a domain identifier,
the method further comprises using the second filter criterion to determine whether the first UPF information matches the query, and
using the second filter criterion to determine whether the first UPF information matches the query comprises determining whether domain identifier specified by the second filter criterion matches the domain identifier specified by the first UPF information.

16. The method of claim 9, wherein using the first filter criterion to determine whether the first UPF information matches the query comprises:
determining whether the IP address specified by the first filter criterion is within the range of public PDU session IP addresses.

17. The method of claim 5, further comprising:
receiving, from a second UPF, a registration request comprising second UPF information for the second UPF, wherein the second UPF information includes second address range information specifying a second range of public IP addresses;
storing the second UPF information;
receiving, from a network function, NF, a query for discovering a UPF that matches the query, wherein the query includes a first filter criterion that specifies an IP address; and
determining that the second UPF information matches the query as a result of determining that: i) the second range of public IP addresses includes the IP address specified by the first filter criterion and ii) no other UPF information maintained by the NRF specifies a range of public IP addresses that includes the IP address specified by the first filter criterion.

18-19. (canceled)

20. A network node, wherein the network node implements a user plane function (UPF) and is configured to perform a method comprising:
sending to a network repository function (NRF) a registration request comprising UPF information for the UPF, the UPF information comprising address range information specifying internet protocol (IP) addresses that can be served by the UPF, wherein the address range information comprises:
first address range information specifying a range of public network address translated (NATed) IP addresses that can be served by the UPF,
second address range information specifying a range of private PDU Session IP addresses that can be served by the UPF, and
third address range information specifying a range of public UE PDU Session IP address that can be served by the UPF.

21. (canceled)

22. A network node, wherein the network node is configured to perform a method comprising:
receiving, from a first user plane function (UPF) a registration request comprising first UPF information for the first UPF, the first UPF information comprising address range information specifying internet protocol (IP) addresses that can be served by the first UPF; and
storing the first UPF information, wherein the address range information comprises:
first address range information specifying a range of public network address translated (NATed) IP addresses that can be served by the first UPF,
second address range information specifying a range of private PDU Session IP addresses that can be served by the first UPF, and
third address range information specifying a range of public UE PDU Session IP address that can be served by the first UPF.

23. (canceled)
